(19) United States
(12) Patent Application Publication
(10) Pub. No.: US 2013/0203352 A1
(43) Pub. Date: Aug. 8, 2013

(54) METHOD AND DEVICE FOR ASSISTING IN THE POSITIONING OF A NEAR-FIELD COMMUNICATION MODULE IN RELATION TO AN ELECTROMAGNETIC TRANSPONDER

(71) Applicant: France Telecom, Paris (FR)

(72) Inventor: Fabrice Baranski, Rennes (FR)

(73) Assignee: FRANCE TELECOM, Paris (FR)

(21) Appl. No.: 13/754,134

(22) Filed: Jan. 30, 2013

(30) Foreign Application Priority Data
Feb. 2, 2012 (FR) 12 50981

(51) Int. Cl. H04B 5/00

(52) U.S. Cl. CPC H04B 5/0025
USPC 455/41.1

(57) ABSTRACT

The invention relates to a method and a terminal for assisting in the positioning of a near-field communication module of a terminal in relation to an electromagnetic transponder placed in an environment. The method comprises a step of acquisition by the terminal of at least one image of visual information representative of the placement of the transponder, a step of analysis of the acquired image to determine a position indicating the placement of the transponder in the environment, a step of determination of at least one movement of the terminal to be performed so as to position the communication module in such a way that a communication can be set up between the communication module and the transponder and a step of restoration of information representative of the at least one movement to be performed.

### CROSS-REFERENCE TO RELATED APPLICATION

This application claims the benefit of French Patent Application No. 12 50981, filed on Feb. 2, 2012, in the French National Institute of Industrial Property, the entire contents of which is incorporated herein by reference.

### FIELD

The invention lies in the field of telecommunication networks. It relates to a device and a method for assisting in the positioning of a near-field communication module in relation to an electromagnetic transponder.

### BACKGROUND

The invention relates generally to telecommunications, and more specifically to the contactless communications that use short-distance radio technologies, notably of RFID (Radio Frequency Identification) type. It applies more particularly to the terminals equipped with physical and software resources including a microprocessor and a near-field communication module generating an electromagnetic field, capable of communicating with electromagnetic transponders, whether they are passive, active or semi-active.

The terminals concerned, hereinafter designated by the expression “mobile terminals”, are terminals which can be moved.

The near-field communications, usually called NFC, primarily based on the ISO (International Standards Organisation) 14443 standard, use wireless technologies to allow for an exchange of information between two peripheral devices separated by a short distance, typically less than ten centimeters. The communications of this type offer numerous applications in the fields of payment or transport for example.

The near-field communications cover two types of applications to which the invention applies:
The first type implements an emulation of a near-field communication module, present on a mobile terminal, to secure electronic transactions between an application stored on the terminal or the module and an external reading terminal which emits electromagnetic waves to read the data on this module.
The second type of applications relates to the reading of data on transponders by the mobile terminal; this is tag reading as defined by the NFC Forum (industrial association responsible for promoting the implementation and the standardization of the NFC technology). An NFC communication is set up between a master, here called terminal, and a slave, here called transponder. For example, the terminal is a mobile telephone and the transponder a tag associated with the service. Such services allow access to all kinds of information: transport and payment applications, internet network access, sending of an SMS or making telephone calls, etc. The setting up of the communication will enable a user of the terminal to read the information contained in the tag by bringing his or her mobile terminal close to the support (poster, catalogue, etc.) on which it is positioned.

The transponder to which the invention applies, equipped with a microprocessor, can be of the passive (not requiring its own power supply), semi-active (if a part of its circuit is powered) or active (if all powered) type.

To set up a communication between the near-field communication module of a terminal and an electromagnetic transponder, a short distance between the two devices and a good orientation of their NFC antennas are necessary.

These two conditions can be difficult to fulfill when the user cannot clearly distinguish the transponder to which he or she should be directed.

It is known practice to associate with the transponder a specific visual signage, in order to indicate the exact placement of the transponder to the user of the terminal. For example, a known technique aiming to offer NFC services in town proposes a simple and recognizable signage, which enables the user of such a service to easily identify the transponder in order to be able to bring his or her mobile terminal close thereto. However, this signage remains difficult to identify if the transponder is surrounded by other transponders with similar signage or if the signages interfere with one another because of the proximity of the transponders.

Furthermore, when the near-field communication module is incorporated in a mobile terminal, the user does not always know the placement of the communication module on his or her terminal, so it is not easy to accurately position the communication module facing the transponder in order to set up a communication.

### SUMMARY

One of the aims of the invention is to provide improvements compared to the prior art.

To this end, it proposes a method for assisting in the positioning of a near-field communication module of a terminal in relation to an electromagnetic transponder placed in an environment. The method comprises the steps of acquisition by the terminal of at least one image of visual information representative of the placement of the transponder, of analysis of the acquired image to determine a position indicating the placement of the transponder in the environment, of determination of at least one movement of the terminal to be performed so as to position the communication module in such a way that a communication can be set up between the communication module and the transponder, and of restoration of information representative of the at least one movement to be performed.

Correlatively, the invention also relates to a terminal for assisting in the positioning of a near-field communication module of the terminal in relation to an electromagnetic transponder placed in an environment. The terminal comprises means for acquiring at least one image of visual information representative of the placement of the transponder, means for analyzing in the acquired image a position indicating the placement of the transponder in the environment, means for determining at least one movement of the terminal to be performed so as to position the communication module in such a way that a communication can be set up between the communication module and the transponder, and means for restoring information representative of the at least one movement to be performed.

By virtue of the method, the terminal according to the invention informs the user as to whether the terminal is positioned correctly or incorrectly in relation to the transponder in order to set up a communication therewith. If the positioning is not correct, it can indicate to said user the direction in which to move his or her terminal in order to optimize his or her chances of setting up a communication with the terminal. Using a conventional terminal that has a simple camera, the user thus has a simple means for assisting in the positioning of his or her terminal in relation to a transponder.

This method has the advantage of not requiring additional equipment on the terminal.

Various embodiments or features mentioned hereinbelow can be added independently or in combination with one another to the steps of the method defined hereinbelow.

The various embodiments or features mentioned hereinbelow can be added independently or in combination with one another to the features of the terminal defined hereinbelow.

According to a particular embodiment of the invention, the method comprises a preliminary step of storage of the geographic position of the transponder, and a step of activation of the method when the communication module is situated at a distance less than a predetermined threshold from the geographic position of the transponder.

Correlatively, the terminal according to this particular embodiment of the invention comprises means for storing the geographic position of the transponder and means for geographically locating the communication module.

The method can thus be activated automatically when the terminal arrives in proximity to the transponder.

According to another particular embodiment of the invention, the step of restoration of information representative of the at least one movement to be performed corresponds to a visual, vocal or tactile restoration of the information or to a combination of a visual and/or vocal and/or tactile restoration of the information.

Correlatively, according to this particular embodiment of the invention, the means of the terminal for restoring information representative of the at least one movement to be performed correspond to visual, vocal or tactile restoration means.

As a preliminary step, the user can configure the mode of restoration of the movement information that he or she prefers or according to his or her physical capabilities, for example if he or she is partially-sighted or hearing-impaired.

According to another particular embodiment of the invention, the determining of the at least one movement of the terminal to be performed comprises a substep of obtaining the position of the communication module in the terminal. This embodiment is advantageous when the position of the near-field communication module has not previously been stored in the memory of the terminal.

According to another particular embodiment of the invention, the analysis of the acquired image comprises a step of application of a shape recognition technique applied to the acquired image and a step of correlation of the recognized shape with visual information shapes contained in a database that can be accessed by the terminal or previously stored on the terminal.

The terminal does not have to first download the shape of the visual information associated with the transponder. It extracts this shape at the time when it needs to and thus has the latest version of the shape for the case where the signage associated with the transponder might have been modified. In this case, the database can be accessed via a database on the internet for example.

The invention also relates to a computer program comprising instructions for the execution of the positioning assistance method according to any one of the particular embodiments of the invention described hereinabove, when the program is executed by a processor.

The invention also relates to a processor-readable storage medium on which is stored a program comprising instructions for the execution of the positioning assistance method according to the any one of the particular embodiments of the invention described hereinabove.

### BRIEF DESCRIPTION OF THE DRAWINGS

Other advantages and features of the invention will become more clearly apparent on reading the following description of a particular embodiment of the invention, given as a simple illustrative and nonlimiting example, and from the appended drawings, in which:

FIG. 1 presents the steps of the method for assisting in the positioning of a near-field communication module of a terminal in relation to an electromagnetic transponder according to a particular embodiment of the invention,

FIG. 2 illustrates the implementation of the steps of the positioning assistance method according to a particular embodiment of the invention,

FIG. 3 presents the structure of a terminal that makes it possible to implement the positioning assistance method according to a particular embodiment of the invention.

### DETAILED DESCRIPTION

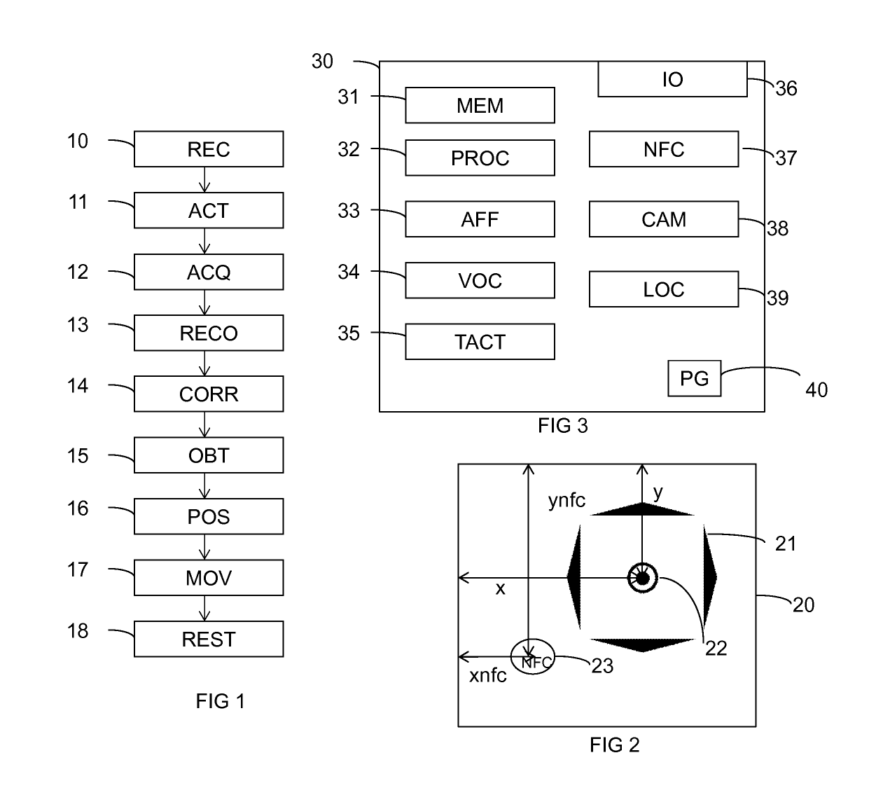

FIG. 1 presents the steps of the method for assisting in the positioning of a near-field communication module of a terminal in relation to an electromagnetic transponder according to a particular embodiment of the invention.

According to a particular embodiment of the invention, the method comprises a step 10 of storing (REC) the geographic position of the transponder with which a user wants to set up a communication via his or her terminal equipped with a near-field communication module.

The geographic position of the transponder can be obtained by the terminal from a database containing the geographic positions of points of interest that the terminal can access by a connection via a communication network for example. The user can also manually enter the geographic position of a point of interest associated with a transponder or of the transponder itself.

According to this particular embodiment of the invention, in a step 11, the activation (ACT) of the positioning assistance method is performed when the terminal detects that it is situated at a distance less than, for example, 2 meters, from the geographic position of the transponder. This detection can be implemented using a geolocation of the terminal and the geographic position of the transponder stored previously.

When the method is activated, either automatically for example according to the embodiment described above, or manually by the user of the terminal, the terminal acquires (ACQ), using its camera, an image or a series of images of visual information representative of the placement of the transponder, in a step 12. The visual information may, for example, correspond to a visual signage as represented by the element 21 of FIG. 2. This visual signage is positioned on the transponder in such a way that a near-field communication module placed facing the center of this signage (represented by 22 in FIG. 2) enables the communication module to be in the optimum conditions to set up a communication with the transponder.

The terminal then analyzes the acquired image in order to identify the position in the acquired image of the visual information associated with the transponder.

According to a particular embodiment of the invention, in a step 13, as is known, the terminal implements a shape recognition step (RECO) applied to the acquired image in order to identify a specific shape represented by the visual signage and associated with the transponder. This identification was implemented during the shape recognition step by a step 14 of correlating (CORR) the recognized shape with visual information shapes contained in a database that can be accessed by the terminal or previously stored on the terminal.

For example, the shape of the visual information may also have been stored on the terminal and associated with the geographic position of the transponder.

According to a particular embodiment of the invention, the visual information may not be positioned on the transponder but in proximity to the transponder. Distance information between the visual information and the transponder may also be stored on the terminal or available in the database containing the visual information shapes.

On completion of the steps 13 and 14, the terminal has been able to correlate the visual information represented on the acquired image and known visual information.

According to another particular embodiment of the invention, the characteristics of the shape of the visual information may have been previously stored on the terminal or can be accessed by the terminal via a communication network, so that the correlation step is not necessary. The terminal implements the shape recognition step applied to the acquired image by searching for the position in the acquired image of the characteristics of the shape of the visual information.

When the terminal has identified the placement in the acquired image of the shape of the visual information, it determines the center of the visual information, corresponding to the element 22 in FIG. 2. In FIG. 2, the center 22 is identified in the acquired image 20 by its coordinates x and y.

With reference to FIG. 1, the terminal obtains (OBT), in a step 15, the position of the near-field communication module in the terminal. The position of the module in the terminal depends on the terminal used. It may be extracted by the method or by the user from a remote database that can be accessed by a communication network. It may also be extracted from the technical characteristics of the terminal, these technical characteristics being able to be previously stored in the terminal or made available by the supplier of the terminal.

In FIG. 2, the position of the near-field communication module (NFC) in the terminal is represented virtually in the acquired image by the element 23. Its position is identified by the coordinates xnfc and ynfc.

In a step 17, the terminal determines (MOV) at least one movement to be performed by the terminal in order to position the near-field communication module facing the center of the visual information. This movement may be determined in the vertical or horizontal direction or depth-wise relative to the distance from the terminal to the transponder.

The movement in the vertical or horizontal direction is determined by the offset between the coordinates x,y of the center of the visual information and xnfc,ynfc of the communication module NFC.

The movement depth-wise can be determined from the measurement in the image of the width If of the shape. The actual width Lf of the shape is a known datum of the terminal, and it may, for example, have been obtained with the characteristics of the shape to be identified or be associated with the correlated shape.

The distance D from the terminal to the transponder can then be obtained according to: D=Lf/((If*tpix)/f), tpix corresponding to the size of a pixel of the camera and f corresponding to the focal distance of the camera.

From the distance from the terminal to the transponder and from the offset determined above, the terminal translates the distance and/or the offset into textual movement information of the type “higher” or “lower” or “more left” or “more right” or “nearer” or into a combination of such information.

The textural information is restored (REST) to the user in a step 18. This restoration may be done in a visual form by the display on the screen of the terminal of the textural movement information determined previously.

According to another particular embodiment of the invention, the restoration may also be done in a vocal form via speakers of the terminal and by the vocalization of the textural information in a known manner by virtue of a vocalization method.

According to another particular embodiment of the invention, the restoration may also be done in a tactile form via vibrators of the terminal positioned on the four edges of the terminal and activated according to the movement to be performed. For example, for a movement to the left, the vibrator located on the left side is activated.

According to another particular embodiment of the invention, the restoration may also be done in the form of a combination of two or three of the restoration modes described above.

FIG. 3 presents the structure of a terminal 30 that makes it possible to implement the positioning assistance method according to a particular embodiment of the invention.

The terminal comprises a storage space 31, for example a memory (MEM), a processing unit 32, equipped for example with a microprocessor (PROC), and driven by the computer program (PG) 40, implementing the positioning assistance method as described in the invention.

On initialization, the code instructions of the computer program 40 are, for example, loaded into a RAM memory before being executed by the processor the processing unit 32. The microprocessor of the processing unit 32 implements the steps of the method for assisting in the positioning of a near-field communication (NFC) module 37 of the terminal 30 in relation to an electromagnetic transponder placed in an environment, and notably the steps of acquisition by the terminal 30 of at least one image of visual information representative of the placement of the transponder, of analysis of the acquired image to determine a position indicating the placement of the transponder in the environment, of determination of at least one movement of the terminal 30 to be performed so as to position the communication module 37 in such a way that a communication can be set up between the communication module 37 and the transponder, and of restoration of information representative of the at least one movement to be performed, according to the instructions of the computer program 40.

For that, the terminal comprises means 38 for acquiring at least one image of visual information representative of the placement of the transponder, for example a camera (CAM).

Modules for analyzing the acquired image and for determining a movement of the terminal to be performed are driven a computer program PG implemented by a processor PROC using a memory MEM.

The terminal also comprises means (33, 34, 35) for restoring information representative of the at least one movement to be performed. These means correspond, for example, to the screen of the terminal (AFF) for a visual restoration, to the speakers (VOC) for a vocal restoration or vibro-tactile effectors (TACT) for a tactile restoration.

According to a particular embodiment of the invention, the terminal also comprises means (10) for connecting to a communication network enabling the terminal to obtain data necessary to the implementation of the method such as, for example, the geographic position of the transponder, the characteristics of the shape of the visual information associated with the transponder, or even the technical characteristics of the terminal.

According to another particular embodiment of the information, the terminal comprises means (MEM) for storing the geographic position of the transponder and means 39 for geographically locating the communication module (LOC).

The terminal may, for example, correspond to a mobile telephone terminal or to any communication terminal equipped with a near-field communication module.

1. A method for assisting in the positioning of a near-field communication module of a terminal in relation to an electromagnetic transponder placed in an environment, which comprises the following steps:
acquisition by the terminal of at least one image of visual information representative of the placement of the transponder,
analysis of the acquired image to determine a position indicating the placement of the transponder in the environment,
determination of at least one movement of the terminal to be performed so as to position the communication module in such a way that a communication can be set up between the communication module and the transponder,
restoration of information representative of the at least one movement to be performed.

2. The method as claimed in claim 1, wherein it comprises a preliminary step of storage of the geographic position of the transponder, and a step of activation of the method when the communication module is situated at a distance less than a predetermined threshold from the geographic position of the transponder.

3. The method as claimed in claim 1, wherein the step of restoration of information representative of the at least one movement to be performed corresponds to a visual, vocal or tactile restoration of the information or to a combination of a visual and/or vocal and/or tactile restoration of the information.

4. The method as claimed in claim 1, wherein the determination of the at least one movement of the terminal to be performed comprises a substep of obtaining the position of the communication module in the terminal.

5. The method as claimed in claim 1, wherein the analysis of the acquired image comprises a step of application of a shape recognition technique applied to the acquired image and a step of correlation of the recognized shape with visual information shapes contained in a database that can be accessed by the terminal or previously stored on the terminal.

6. A terminal for assisting in the positioning of a near-field communication module of the terminal in relation to an electromagnetic transponder placed in an environment, the terminal comprising:
means for acquiring at least one image of visual information representative of the placement of the transponder,
means for analyzing the acquired image to determine a position indicating the placement of the transponder in the environment,
means for determining at least one movement of the terminal to be performed so as to position the communication module in such a way that a communication can be set up between the communication module and the transponder,
means for restoring information representative of the at least one movement to be performed.

7. The terminal as claimed in claim 6, wherein it comprises means for storing the geographic position of the transponder and means for geographically locating the communication module.

8. The terminal as claimed in claim 6, wherein the means for restoring information representative of the at least one movement to be performed correspond to visual, vocal or tactile restoration means.

9. A non-transitory computer program product comprising instructions for the execution of the positioning assistance method as claimed in claim 1, when the program is executed by a processor.

10. A processor-readable storage medium on which is stored a program comprising instructions for the execution of the positioning assistance method as claimed in claim 1.
